(19) United States
(12) Patent Application Publication
(10) Pub. No.: US 2011/0117453 A1
(43) Pub. Date: May 19, 2011

(54) FUEL REFORMER AND POWER GENERATION APPARATUS USING THE SAME

(75) Inventors: Yuichi Tokita, Kanagawa (JP); Hideki Sakai, Kanagawa (JP); Hideyuki Kumita, Kanagawa (JP); Masaya Kakuta, Tokyo (JP); Takaaki Nakagawa, Kanagawa (JP); Hiroki Mita, Kanagawa (JP)

(73) Assignee: SONY CORPORATION, Tokyo (JP)

(21) Appl. No.: 13/001,902

(22) PCT Filed: Jun. 30, 2009
(86) PCT No.: PCT/JP2009/061967

§ 371 Date: Dec. 29, 2010

(30) Foreign Application Priority Data
Jul. 14, 2008 (JP) 2008-182283
Mar. 19, 2009 (JP) 2009-068040
May 26, 2009 (JP) 2009-126873

(51) Int. Cl. H01M 8/16

(52) U.S. Cl. 429/401

(57) ABSTRACT

The present invention provides a fuel reformer which enables power generation to be actually performed even in the case of using very-safe familiar things such as food and drink and food scraps as a fuel of a biofuel cell. The fuel reformer is used for a fuel cell which generates power as an oxidation reduction reaction progresses using enzyme as a catalyst, and has: a primary fuel introduction unit for introducing a primary fuel; a fuel reforming unit communicating with the primary fuel introduction unit and reforming the primary fuel to a secondary fuel from which electrons can be emitted by an oxidation reduction reaction using enzyme as a catalyst; and a secondary fuel supplying unit communicating with the fuel reforming unit and supplying the secondary fuel to the fuel cell.

### TECHNICAL FIELD

The present invention relates to a fuel reformer for a fuel cell. More particularly, the invention relates to a fuel reformer for a fuel cell, which generates power when an oxidation-reduction reaction progresses using an enzyme as a catalyst and to a power generation apparatus using the same.

### BACKGROUND ART

In recent years, attention is paid to a fuel cell in which an oxidation-reduction enzyme is immobilized as a catalyst on at least one of electrodes, an anode or a cathode (hereinbelow, called “biofuel cell”) as a high-capacity, very-safe fuel cell of the next generation. In the biofuel cell, electrons are efficiently taken from a fuel, which is not easily reacted with a normal industrial catalyst such as glucose or ethanol.

A reaction scheme of a general biofuel cell will be described with reference to FIG. 12. In a biofuel cell using glucose as a fuel, an oxidation reaction of glucose progresses in an anode, and a reduction reaction of oxygen (O₂) in atmosphere progresses in a cathode.

The flow of electrons will be described specifically. In the anode, the electrons are transferred in order of glucose, glucose dehydrogenase, NAD+ (Nicotinamide Adenine Dinucleotide), diaphorase, an electron transfer mediator, and an electrode (carbon).

On the other hand, in the cathode, the electrons released from the negative electrode are transferred in order of an electrode (carbon), an electrode transfer mediator, and bilirubin oxidase (BOD) and a reduction reaction progresses using the electrons and oxygen supplied from the outside, thereby generating electric energy.

Attention is paid to such a biofuel cell as a very-safe fuel cell, and biofuel cells which are not limited to glucose as a fuel used, using various fuels, and variously devised are being developed.

For example, patent document 1 discloses a fuel cell, which can use, as a fuel, alcohol such as methanol, ethanol, propanol, glycerin, or polyvinyl alcohol, aldehyde such as formaldehyde or acetaldehyde, or the like. The fuel cell uses pyrrolo-quinoline quinone (PQQ) as a prosthetic group of oxidation-reduction enzyme and uses an enzyme electrode having an osmium complex in which at least one bidentate ligand made of bipyridylamin or bipyridylamin derivative (Ra to Ri are H or substituent group) is coordinated in osmium, so that high voltage and high current density can be obtained.

Patent document 2 also discloses an enzyme electrode capable of using, as a fuel, monosaccharide such as glucose, alcohol such as methanol or ethanol, or the like. The enzyme electrode has a structure in which an electron mediator for oxidizing a substrate dehydrogenase, which oxidizes a specific substrate and the substrate dehydrogenase to assist transmission of electrons to the electrode is fixed in a layer form as an underlayer on the electrode. With the simplified electrode structure, the enzyme electrode has both stable enzyme immobilization capability and high substrate reactivity.

By the way, since the biofuel cell can be used, as fuel, a material which is very safe to a human body such as glucose solution, theoretically, an edible material containing sugar, fat, protein, and the like, wastes such as food scraps can be used as a fuel to generate power.

However, in reality, electrons are not possible to be taken by the oxidation reduction reaction from food and drink, food scraps, and the like without changing the form and due to existence of a substance causing enzyme inhibition or an impurity which changes pH of the solution or salt concentration, there is the case that the cell performance deteriorates considerably. Under the circumstances, there are still problems to be technically solved in order to generate power by using edible materials including sugar, fat, protein, and the like, wastes such as food scraps, and the like.

### CITATION LIST

### Patent Document

Patent document 1: Japanese Unexamined Patent Application Publication No. 2008-59800
Patent document 2: Japanese Unexamined Patent Application Publication No. 2007-225305

### SUMMARY OF THE INVENTION

A biofuel cell is a cell which can use, as a fuel, safe, familiar things in theory but, as described above, it is difficult to achieve it in reality. In practice, a fuel cartridge or the like for a biofuel cell has to be prepared, and it is troublesome.

Consequently, a main object of the present invention is to provide a fuel reformer capable of actually generating power even in the case of using safe and familiar things such as food and drink and food scraps as a fuel of a biofuel cell and a power generation apparatus using the same.

A fuel reformer according to the invention is used for a fuel cell which generates power as an oxidation reduction reaction progresses using an enzyme as a catalyst, and has: a primary fuel introduction unit for introducing a primary fuel; a fuel reforming unit communicating with the primary fuel introduction unit and reforming the primary fuel to a secondary fuel from which electrons can be emitted by an oxidation reduction reaction using an enzyme as a catalyst; and a secondary fuel supplying unit communicating with the fuel reforming unit and supplying the secondary fuel to the fuel cell.

The fuel reformer according to the invention may further include a fuel refining unit for refining the secondary fuel, between the fuel reforming unit and the secondary fuel supplying unit.

The configuration of the fuel refining unit is not limited as long as it can refine the secondary fuel. For example, a filter is provided to remove an insoluble component in the secondary fuel, thereby enabling the secondary fuel to be refined.

The fuel refining unit may be provided with heating means to aggregate and remove polymer components and the like contained in the secondary fuel before refining.

Further, the fuel refining unit may be provided with an ion exchange resin layer in order to control ion strength in the fuel by removing salt and the like contained in the secondary fuel before refining.

Preferably, the fuel reformer according to an embodiment of the invention is provided with first control means for controlling introduction of the primary fuel to the fuel reforming unit on the basis of a state of the primary fuel introduced in the primary fuel introduction unit, in order to eliminate a thing which is not possible to be reformed.

In addition, by providing reforming method selecting means for selecting a fuel reforming method in the fuel reforming unit on the basis of a state of the primary fuel introduced in the fuel reforming unit, the fuel reformer according to the invention can be variously used and adapted to a plurality of kinds of primary fuels.

Further, preferably, the fuel reformer according to the invention is further provided with second control means for controlling transmission of the secondary fuel from the fuel reforming unit on the basis of a state of the secondary fuel reformed in the fuel reforming unit, in order to prevent supply to the cell in the case where the reformed secondary fuel is not possible to be used as the fuel of the fuel cell.

Preferably, the fuel reformer according to the invention is further provided with third control means for controlling transmission of the secondary fuel from the fuel refining unit on the basis of the state of the secondary fuel refined in the fuel refining unit, in order to prevent supply to the cell in the case where the refined secondary fuel cannot be used as the fuel of the fuel cell.

The fuel reformer according to an embodiment of the invention may be further provided with an electrolyte solution supplying unit for supplying an electrolyte solution, between the fuel refining unit and the secondary fuel supplying unit, in order to adjust the fuel to an ideal fuel adapted to the fuel cell.

In this case, it is preferable to provide electrolyte control means for controlling an electrolyte supply amount from the electrolyte solution supplying unit on the basis of the state of the secondary fuel refined in the fuel refining unit.

A power generation apparatus according to the invention includes: a fuel reformer according to the invention, for reforming a primary fuel to a secondary fuel; and a fuel cell part which generates power by the secondary fuel.

The fuel cell part has: a fuel tank section for storing the secondary fuel supplied from the secondary fuel supplying unit; an anode communicating with the fuel tank; and a cathode connected to the anode in a state where proton conduction is possible.

Technical terms used in the present invention are as follows.

“Primary fuel” denotes a fuel containing a substance in which the oxidation reduction reaction does not progress in the case of using an enzyme used for a target fuel cell, or a fuel containing a substance in which the oxidation reduction reaction progresses but from which electrons are not released.

“Secondary fuel” denotes a fuel including a substance from which electrons can be released by the oxidation reduction reaction using, as a catalyst, an enzyme used for a target fuel cell.

With the fuel reformer according to the present invention, power can be actually generated by using safe and familiar things such as food and drink and food scraps as the fuel of the biofuel cell.

### BRIEF DESCRIPTION OF THE DRAWINGS

FIG. 1 is a conceptual diagram illustrating a configuration of a fuel reformer according to the present invention.

FIG. 2 is a schematic diagram illustrating a configuration of a fuel refining unit.

FIG. 3 is a schematic diagram illustrating another configuration of the fuel refining unit.

FIG. 4 is a schematic diagram showing further another configuration of the fuel refining unit.

FIG. 5 is a schematic diagram showing further another configuration of the fuel refining unit.

FIG. 6 is a schematic diagram showing a concrete configuration of a fuel reformer.

FIG. 7 is a schematic diagram showing another concrete configuration of the fuel reformer.

FIG. 8 is a schematic diagram showing a configuration of a power generation apparatus according to the invention.

FIG. 9 is a schematic diagram showing a configuration of a fuel cell unit.

FIG. 10 is a characteristic diagram showing the relation between cellulase processing time and current value change.

FIG. 11 is a conceptual diagram showing a process of decomposition (reforming) from cellulose to glucose.

FIG. 12 is a conceptual diagram showing a reaction scheme of a general biofuel cell.

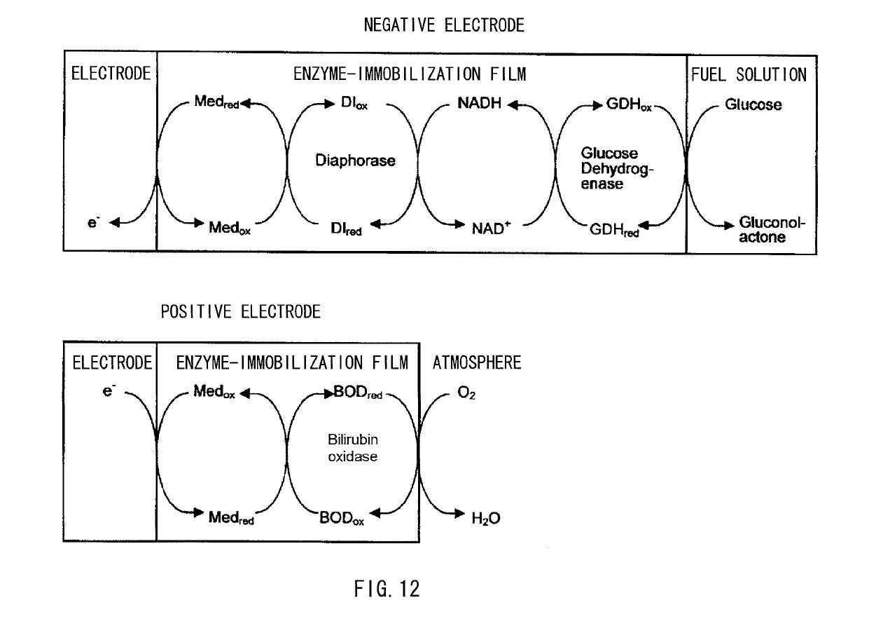

### DESCRIPTION OF EMBODIMENTS

Preferred modes for carrying out the present invention will be described in detail below. Embodiments to be described below are just an example of representative embodiments of the present invention. The scope of the present invention will not be interpreted narrowly.

<Fuel Reformer>

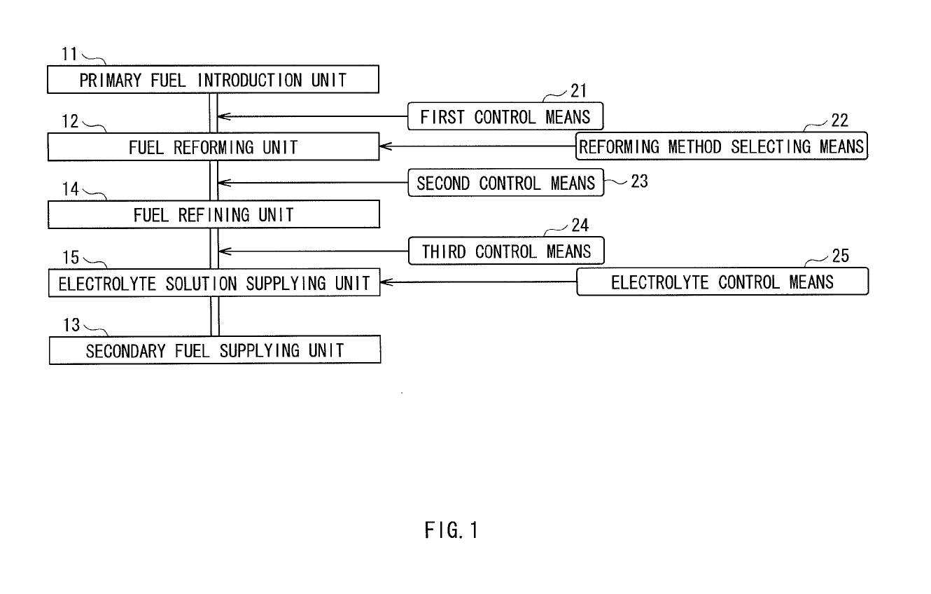

FIG. 1 is a conceptual diagram showing a configuration of a fuel reformer 1 according to the present invention. The fuel reformer 1 has, roughly, a primary fuel introduction unit 11, a fuel reforming unit 12, and a secondary fuel supplying unit 13. As necessary, it may have a fuel refining unit 14, an electrolyte solution supplying unit 15, and various control means. The configuration, function, effect, and the like of each of the components will be described below.

(1) Primary Fuel Introducing Unit 11

The primary fuel introducing unit 11 is used to introduce fuel into the fuel reformer 1. The form of the primary fuel introducing unit 11 is not limited but can be freely designed as long as primary fuel is introduced to the fuel reformer 1. For example, by using the principle of pressure injection, negative-pressure injection, contact water absorption, or capillary action, a primary fuel can be introduced into the fuel reformer 1 according to the invention.

In addition, according to the kind of a fuel used, the structure of the primary fuel introducing unit 11 can be devised. For example, there is a configuration of introducing fuel by providing the primary fuel introducing unit 11 with a projection structure (such as needle or pinholder) and sticking a solid fuel with the projection structure. Further, the primary fuel introducing unit 11 may be devised by using a pump or valve so that a fuel having relatively high viscosity can be also introduced. Further, for example, in the case of using paper or the like as the primary fuel, the primary fuel introducing unit 11 may be devised to have a shredder function or the like.

The primary fuel which can be reformed by the fuel reformer 1 is not particularly limited as long as it can be decomposed to a substance from which electrons are released by an oxidation reduction reaction using, as a catalyst, an enzyme used for a target fuel cell by an enzyme, acid or alkali, a microorganism, heating, or the like. For example, drink such as juice, sports drink, sugar water, alcohol, or the like, lotion such as skin lotion, or the like can be used. That is, by using the fuel reformer 1, food, lotion, and the like used in daily life can be reformed to a fuel for a fuel cell, which generates power when the oxidation reduction reaction using an enzyme as a catalyst progresses (hereinbelow, called “biofuel cell”).

Particularly, it is desirable to use, as a primary fuel, a fuel containing carbohydrate, protein, glycoprotein, fatty acid, or the like. By decomposing the primary fuel and reforming it to monosaccharide, amino acid, fatty acid, or the like, the fuel can be suitably used as the fuel of a biofuel cell. In addition, the fuel reformer 1 can reform not only a liquid but also a solid substance such as waste wood, waste paper, food waste, or the like used as the primary fuel to a fuel suitable as a fuel of a biofuel cell. Such a solid substance (particularly, waste wood, waste paper, or the like) has not been possible to be used as a fuel of a biofuel cell since sufficiently high reaction speed is not obtained even in the case of using degrading enzyme. However, the fuel reformer 1 can use, as a fuel of a biofuel cell, even a solid substance (particularly, waste wood, waste paper, or the like) by performing various fuel reforming which will be described later.

Information on substances which can be used as a fuel and, on the contrary, substances which is not possible to be used is written in, for example, a power generation apparatus or an electronic device or its package, or package of food and drink, thereby warning the user. In addition, by making a container housing a substance which is not possible to be used as a fuel and the fuel reformer 1 uncontactable, the unusable fuel can be prevented from being erroneously used.

(2) Fuel Reforming Unit 12

The fuel reforming unit 12 is communicated with the primary fuel introduction unit 11 and reforms a primary fuel to a secondary fuel capable of emitting electrons by the oxidation reduction reaction using enzyme used for a target fuel cell as a catalyst. The reforming method in the fuel reforming unit 12 can be freely selected according to the kind of the primary fuel used. For example, one or more kinds of methods such as a chemical, biological method using enzyme, acid, alkali, or microorganism, a physical method performing heating, pressurization, or the like can be used.

In the following, concrete examples in the case of using, as the primary fuel, (a) cellulose, (b) starch, (c) chitin/chitosan, (d) mucoperiosteum (hyaluronan, chondroitin, or the like), (e) disaccharide (maltose, octamethyl maltose, cellobiose, isomaltose, lactose, sucrose, or the like), (f) protein, and (g) fat will be described respectively.

(a) Cellulose

### [Decomposition Using Enzyme]

This is a method of reforming to monosaccharide (glucose) as a secondary fuel by performing decomposition using single or plural cellulases adapted to various celluloses in accordance with the kind of cellulose used as the primary fuel. Examples of cellulase used include endoglucanase, cellobiodrolase, and hemicellulase.

[Dilute Sulfuric Acid Two-Stage Saccharification]

A dilute sulfuric acid two-stage saccharification method is one of acid saccharification methods and is a method of saccharifying a hemicellulose component by using dilute sulfuric acid, separating the resultant to a saccharified solution and a solid of the cellulose component and, further, saccharifying the cellulose component by dilute sulfuric acid under another condition. By using the method, cellulose as the primary fuel is reformed to monosaccharide (glucose) as the secondary fuel. Enzyme can be used for saccharification of the cellulose component.

[Method Using Supercritical Fluid or Subcritical Fluid]

This method is a method of hydrolyzing cellulose as the primary fuel in a supercritical fluid or a subcritical fluid of water and carbon dioxide, thereby reforming the cellulose to monosaccharide (glucose) as the secondary fuel.

[Decomposition Using Pressurized Thermal Water Solvent]

This is a method of hydrolyzing cellulose as the primary fuel by using a pressurized thermal water solvent under existence of an oxidant or the like as necessary, thereby reforming the cellulose to monosaccharide (glucose) as the secondary fuel.

[Decomposition Using Solid Oxide Catalyst]

This is a method of hydrolyzing cellulose as the primary fuel by using a solid oxide catalyst such as activated carbon, thereby reforming the cellulose to monosaccharide (glucose) as the secondary fuel.

[Decomposition Using Cellulolytic Fungus]

This is a method of saccharifying cellulose as the primary fuel by hydrolyzing the cellulose using a cellulolytic fungus such as a wood rotting fungus, thereby reforming the cellulose to monosaccharide (glucose) as the secondary fuel.

(b) Starch

### [Decomposition Using Enzyme]

This is a method of reforming to monosaccharide (glucose) as a secondary fuel by performing decomposition using single or plural degrading enzyme(s) adapted to various starches in accordance with the kind of a starch used as the primary fuel. Examples of degrading enzymes used include α-amylases, β-amylases, and α-glycosidases.

[Dilute Sulfuric Acid Saccharification]

This is a method of saccharifying starch to dextrin maltose and then to monosaccharide (glucose) as the secondary fuel by adding dilute sulfuric acid to a starch aqueous solution as the primary fuel and heading the resultant.

[Decomposition Using Starch Decomposing Fungus]

This is a method of saccharifying starch as the primary fuel by using microorganisms having starch degradation ability such as starch degrading lactic acid bacterium or starch degrading Bacillus cereus, thereby reforming the starch to monosaccharide (glucose) as the secondary fuel.

(c) Chitin/Chitosan

### [Decomposition Using Enzyme]

This is a method of reforming to monosaccharide (N-acetylglucosamine, glucosamine, or the like) as a secondary fuel by performing decomposition using single or plural degrading enzyme(s) adapted to various chitins and various chitosans in accordance with the kind of chitin/chitosan used as the primary fuel. Examples of degrading enzymes used include chitinases and chitosanases.

[Sulfuric Acid Hydrolysis]

This is a method of hydrolyzing chitin/chitosan as the primary fuel by using sulfuric acid to thereby reforming chitin/chitosan to monosaccharide (N-acetylglucosamine, glucosamine, or the like) as the secondary fuel. In addition, in the decomposition, sulfuric acid hydrolysis in two stages can be performed.

[Decomposition Using Chitin/Chitosan Decomposing Fungus]

This is a method of reforming chitin/chitosan as the primary fuel to monosaccharide (N-acetylglucosamine, glucosamine, or the like) as a secondary fuel by using microorganisms having chitin/chitosan decomposing ability such as vibrio.

(d) Mucoperiosteum (Hyaluronan, Chondroitin, or the Like)

### [Decomposition Using Enzyme]

This is a method of reforming mucoperiosteum to monosaccharide (glucuronic acid, N-acetylglucosamine, or the like) as a secondary fuel by performing decomposition using single or plural degrading enzyme(s) adapted to various mucoperiosterums in accordance with the kind of the mucoperiosterum (hyaluronan, chondroitin or the like) used as the primary fuel. In the case of hyaluronan, examples of degrading enzymes used include hyaluronidase.

[Hydrolysis Method]

This is a method of reforming mucoperiosteum as the primary fuel to monosaccharide (glucuronic acid, N-acetylglucosamine, or the like) as a secondary fuel by performing hydrolysis with weak acid or weak base by using the nature of the mucoperiosteum which can be easily hydrolyzed in the presence of weak acid or weak base.

[Decomposition Using Mucoperiosterum Decomposing Fungus]

This is a method of reforming mucoperiosteum as the primary fuel to monosaccharide (glucuronic acid, N-acetylglucosamine, or the like) as a secondary fuel by using microorganisms having capability of decomposing mucoperiosterum.

(e) Disaccharide (Maltose, Octamethyl Maltose, Cellobiose, Isomaltose, Lactose, Sucrose, or the Like)

### [Decomposition Using Enzyme]

This is a method of reforming diaccharide (maltose, octamethyl maltose, cellobiose, isomaltose, lactose, sucrose, or the like) used as the primary fuel to monosaccharide (glucose, fructose, or the like) as a secondary fuel by performing decomposition using single or plural degrading enzyme(s) adapted to various diaccharides in accordance with the kind of the diaccharide used as the primary fuel. Examples of the degrading enzyme used include lactases in the case of lactose, sucrases in the case of sucrose, and maltases in the case of maltose.

[Decomposition Using Diaccharide Decomposing Fungus]

This is a method of reforming diaccharide as the primary fuel to monosaccharide (glucose, fructose, or the like) as a secondary fuel by using microorganisms having capability of decomposing diaccharide.

(f) Protein

### [Decomposition Using Enzyme]

This is a method of reforming protein used as the primary fuel to amino acids as a secondary fuel by performing decomposition using single or plural degrading enzyme(s) adapted to various proteins in accordance with the kind of the protein used as the primary fuel. Examples of the degrading enzyme used include chmotrypsin, subtilisin, pepsine, cathepsin D, HIV protease, thermolysin, papain, and caspase.

(g) Fat

### [Decomposition Using Enzyme]

This is a method of reforming fat to glycerol and fatty acid as a secondary fuel by performing decomposition using single or plural degrading enzyme(s) adapted to various fats in accordance with the kind of the fat used as the primary fuel. An example of the degrading enzyme used is lipases.

(3) Secondary Fuel Supplying Unit 13

The secondary fuel supplying unit 13 is communicated with the fuel reforming unit 12 and is used to supply a secondary fuel reformed in the fuel reforming unit 12 to a biofuel cell. The form of the fuel supplying unit 13 is not limited and the fuel supplying unit 13 can be freely designed as long as it can introduce the secondary fuel to a biofuel cell. For example, it can supply the secondary fuel to a biofuel cell by using the principle such as pressure injection, negative-pressure injection, contact water absorption, or capillary action.

(4) Fuel Refining Unit 14

The fuel refining unit 14 refines the secondary fuel reformed in the fuel reforming unit 12. As described above, the fuel reformer 1 can reform various primary fuels to secondary fuels which can be used as fuels of biofuel cells. However, there is a case such that a substance which disturbs enzyme reaction in a biofuel cell is included in the secondary fuel, or an impurity which changes pH of a solution or salt concentration exists. When the enzyme reaction disturbing substance, impurity, or the like exists, in an enzyme electrode in a biofuel cell, decrease in enzyme activity, deactivation of enzyme, destabilization of an enzyme immobilizing film, destruction of the enzyme immobilizing film, and the like may be caused. As a result, a problem such that power is not smoothly generated may occur.

To address the problem, the fuel reformer 1 is provided with the fuel refining unit 14 by which the reformed secondary fuel can be refined. The method of refining the secondary fuel performed in the fuel refining unit 14 is not limited but can be freely selected according to the kind of the secondary fuel and the enzyme reaction disturbing substance and the impurity included in the secondary fuel. For example, one or more methods such as a method of using a filter, a heating method, a method using an ion exchange resin layer, and a method of using a gel filter column can be freely combined and executed. Each of the methods will be described below.

(a) Filter 141

By using a filter 141, an insoluble component existing in the secondary fuel can be removed. As a result, damage on the enzyme electrode can be lessened. The kind of the filter 141 used for the fuel refining unit 14 in the fuel reformer 1 is not limited. One or more kinds of known filters can be freely selectively used. Examples are polycarbonate, polypropylene, mixed cellulose ester, polyvinylidene fluoride, fluorine resin (PTFE), nylon, cellulose nitrate, fiberglass, polyether sulfone, polyvinyl chloride (PVC), and the like. Filters 141 of the same kind or different kinds may be stacked.

(b) Heating Means 142

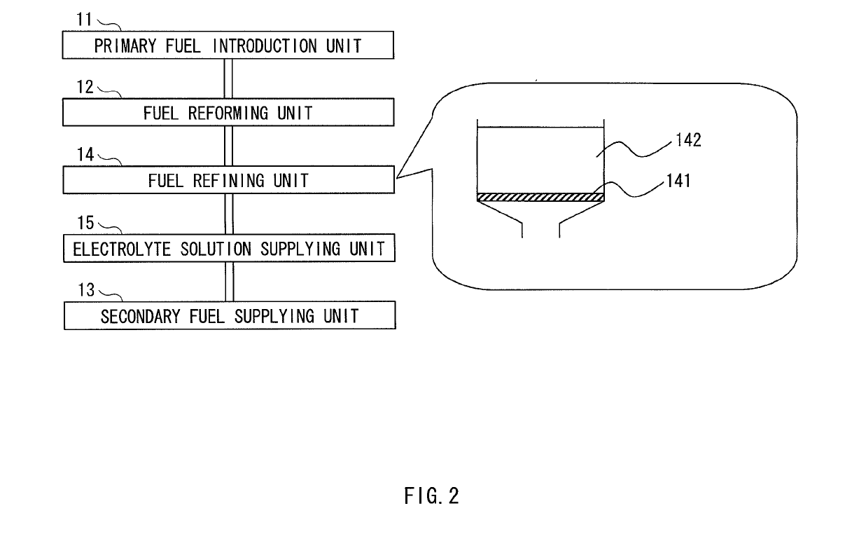

By heating the secondary fuel, polymer components such as proteins causing enzyme reaction inhibition, which are dissolved in a solution can be aggregated. By using heating means 142 in combination with the filter 141 as shown in FIG. 2, for example, the polymer components and the like heated and aggregated by the heating means 142 are removed by using the filter 141. Thus, the polymer components and the like can be removed more reliably.

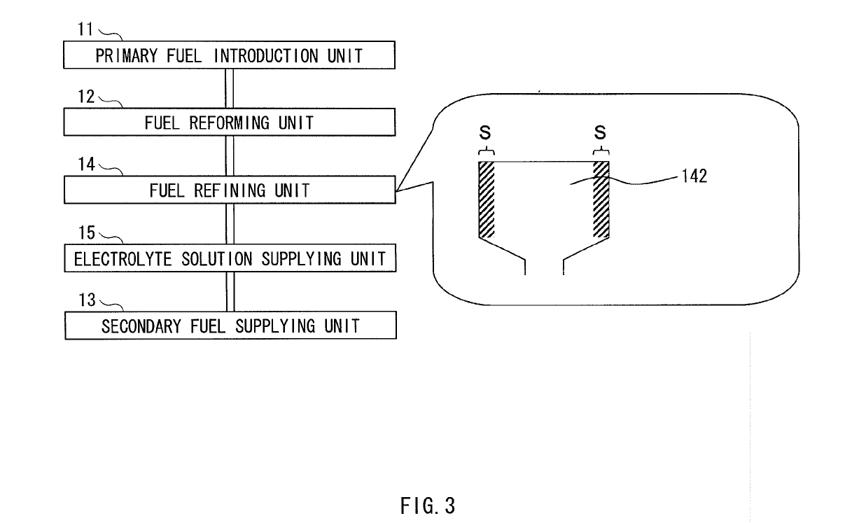

The method of removing the polymer components and the like is not limited to the method of using the filter 141. For example, as shown in FIG. 3, by processing a surface S and the like of side walls in parts to be heated so as to absorb polymer components and the like, the polymer components and the like aggregated by the heating means 141 can be also absorbed. In this case, by stirring the solution while heating, the polymer components and the like can be absorbed more reliably.

By removing the polymer components and the like by using the heating means 142 as described above, enzyme reaction inhibition in the enzyme electrode of a biofuel cell and damage on the enzyme electrode are lessened. As a result, efficient power generation can be performed.

In addition, the heating temperature in the heating means 142 can be freely set according to a target polymer component or the like to be removed. For example, in the case of protein, 40° C. to 60° C. is preferable.

(c) Ion Exchange Resin Layer 143

By disposing layers of ion exchange resins absorbing cations or anions in the fuel refining unit 14, salt in the secondary fuel solution can be removed. When ion strength is unstable, there is the possibility that an enzyme immobilizing film in the enzyme electrode of the biofuel cell may be destroyed. However, by providing an ion exchange resin layer 143 in the fuel refining unit 14, salt in the secondary fuel solution is removed and ion strength of the secondary fuel can be controlled. Therefore, damage on the enzyme electrode can be lessened.

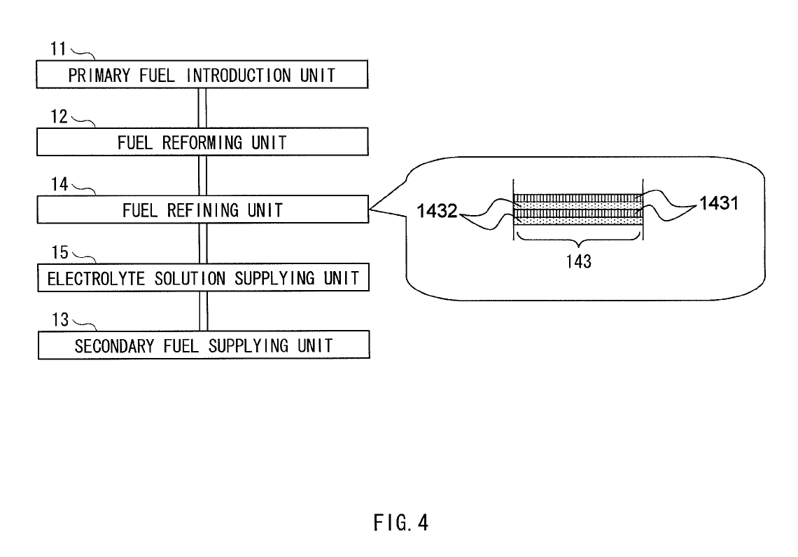

The concrete configuration of the ion exchange resin layer 143 is not limited, but the ion exchange resin layer 143 can be freely designed according to a kind of salt removed or the like. For example, as shown in FIG. 4, the ion exchange resin layer 143 having a multilayer structure can be formed by alternately stacking a cationic ion exchange resin 1431 and an anionic ion exchange resin layer 1432.

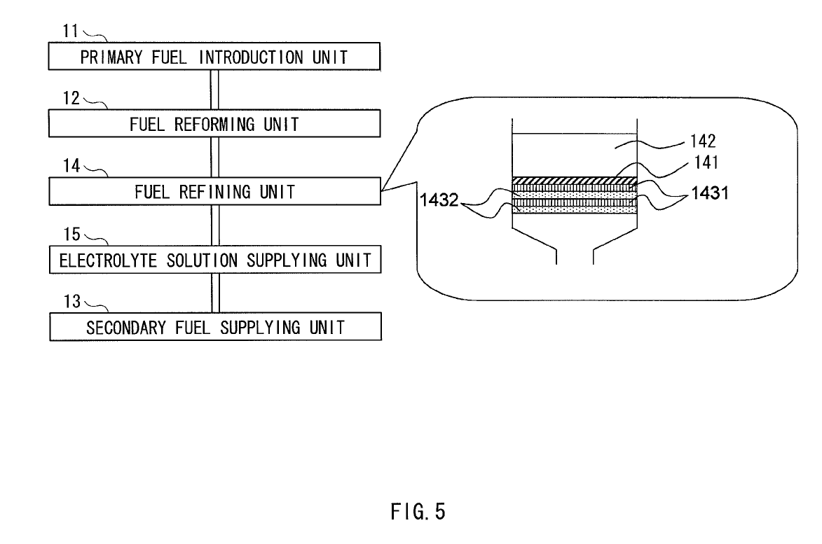

The ion exchange resin layer 143 can be used by combining the filter 141 and the heating means 142. For example, as shown in FIG. 5, by heating the secondary fuel by using the heating means 142, the polymer components and the like in the secondary fuel are aggregated. Next, the aggregated polymer components and insoluble components are removed by using the filter 141. Subsequently, salt in the secondary fuel is removed by using the ion exchange resin layer 143. In such a manner, the secondary fuel can be refined step by step.

The kind of the ion exchange resin used for the ion exchange resin layer 143 is not limited, and known resins can be freely employed. For example, a material obtained by sulfonating a styrene-divinylbenzene copolymer or a material made by alkylammonium can be used.

(d) Gel Filter Column

Although not shown, by disposing a gel filter column in the fuel refining unit 14, a low-molecular component in the secondary fuel solution is captured in the gel filter column and removed from the secondary fuel. The gel filter column can be used in combination with the filter 141, the heating means 142, and the ion exchange resin layer 143.

In addition, the kind of the gel filter column used for the fuel refining unit 14 is not limited but a known gel filter column can be freely employed. For example, the gel filter column using silica gel, substituted silica gel, polyhydroxy methacrylate, or the like is used.

(5) Electrolyte Solution Supplying Unit 15

The fuel reformer 1 may be provided with the electrolyte solution supplying unit 15 for supplying an electrolyte solution to the secondary fuel so that the secondary fuel refined in the fuel refining unit 14 becomes a more ideal fuel of a biofuel cell. By supplying the electrolyte solution to the refined secondary fuel to adjust the secondary fuel, the biofuel cell using the adjusted secondary fuel can display ideal power generation performance.

The kind of the electrolyte solution supplied by the electrolyte solution supplying unit 15 is not limited but can be freely selected in accordance with the kind of the secondary fuel supplied. Examples include buffer solutions of compounds containing an imidazole ring such as dihydrogenphosphate ions (H₂PO₄⁻) generated by sodium dihydrogen phosphate (NaH₂PO₄), potassium dihydrogen phosphate (KH₂PO₄), or the like, 2-amino-2-hydroxymethyl-1,3-propanediol (abbreviated name is tris), 2-(N-morpholino) ethane sulfonic acid (MES), cacodylic acid, carbonic acid (H₂CO₃), hydrogen citrate ion, N-(2-acetoamide)iminodiacetic acid (ADA), piperazine-N,N′-bis(2-ethanesulfonic acid) (PIPES), N-(2-acetoamide)-2-aminoethanesulfonic acid (ACES), 3-(N-morpholino)propanesulfonic acid (MOPS), N-2-hydroxyethyl piperazine-N′-2-ethanesulfonic acid (HEPES), N-2-hydroxyethyl piperazine-N′-3-propanesulfonic acid (HEPPS), N-[tris(hydroxymethyl)methyl]glycine (abbreviated name is tricine), glycylglycine, N,N-bis(2-hydroxyethyl)glycine (abbreviated name is bicin), imidazole, triazole, pyridine derivative, bipyridine derivative, imidazole derivatives (histidine, 1-methyl imidazole, 2-methyl imidazole, 4-methyl imidazole, 2-ethyl imidazole, imidazole-2-caroxylic acid ethyl, imidazole-2-carboxy aldehyde, imidazole-4-carboxylic acid, imidazole-4,5-dicarboxylic acid, imidazole-1-yl-acetic acid, 2-acetyl benzimidazole, 1-acetylimidazole, N-acetylimidazole, 2-amino benzimidazole, N-(3-aminopropyl)imidazole, 5-amino-2-(trifluoromethyl)benzimidazole, 4-azabenz imidazole, 4-aza-2-mercaptobenz imidazole, benzimidazole, 1-benzyl imidazole, and 1-butyl imidazole).

(6) Various Control Means

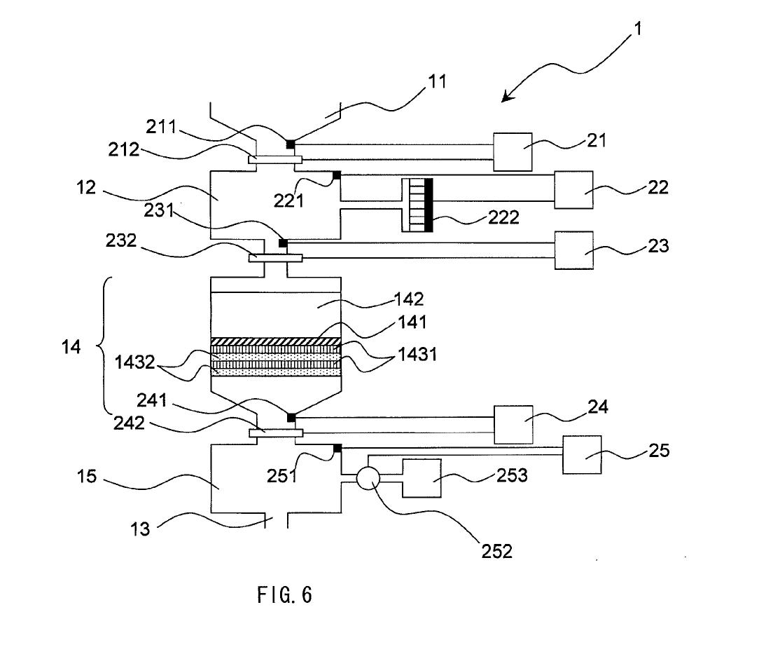

The fuel reformer 1 may be provided with various controls means such as first control means 21, reforming method selecting means 22, second control means 23, third control means 24, and electrolyte control means 25 in different parts. Each of the control means will be described below with reference to FIG. 6.

(a) First Control Means 21

The first control means 21 is control means for controlling introduction of the primary fuel to the fuel reforming unit 12 on the basis of the state of the primary fuel introduced in the primary fuel introducing unit 11. For example, in the case such that the primary fuel introduced in the primary fuel introducing unit 11 has a property that it is not possible to be reformed by the fuel reformer 1, introduction to the fuel reforming unit 12 can be stopped in advance so as not to ruin the function of the fuel reforming unit 12. In the case such that the amount of the primary fuel introduced in the primary fuel introducing unit 11 is too large, the amount of introduction to the fuel reforming unit 12 can be adjusted so as not to ruin the function of the fuel reforming unit 12.

A concrete control method is not limited. For example, a sensor 211 is provided for the primary fuel introducing unit 11, an interruption plate or adjustment valve such as a shutter 212 capable of interrupting or adjusting passage of the primary fuel is mounted between the primary fuel introducing unit 11 and the fuel reforming unit 12, and the state such as the property and the introduction amount of the primary fuel is detected by the sensor 211, and the interruption plate, the adjustment valve, or the like such as the shutter 212 is opened/closed, thereby enabling introduction of the primary fuel to the fuel reforming unit 12 to be controlled.

(b) Reforming Method Selecting Means 22

The reforming method selecting means 22 is means for selecting a primary fuel reforming method in the fuel reforming unit 12 on the basis of the state of the primary fuel introduced in the fuel reforming unit 12. By providing the reforming method selecting means 22, the fuel reformer 1 can be regarded as a reformer which can be variously used and adapted to various kinds of primary fuels.

A concrete selecting method is not limited. For example, a sensor 221 is provided for the fuel reforming unit 12, a degrading enzyme storing unit 222 storing various degrading enzymes is mounted so as to be connected to the fuel reforming unit 12, the kind of the primary fuel is detected by the sensor 221, and a degrading enzyme corresponding to the kind is injected from the degrading enzyme storing unit 222 to the fuel reforming unit 12, thereby a reforming method according to the kind of the primary fuel to be selected.

(c) Second Control Means 23

The second control means 23 is control means for controlling transmission of the secondary fuel from the fuel reforming unit 12 on the basis of the state of the secondary fuel reformed in the fuel reforming unit 12. For example, transmission of the secondary fuel from the fuel reforming unit 12 can be stopped in advance so as not to ruin the function of the biofuel cell in a case such that the secondary fuel reformed in the fuel reforming unit 12 has a property such that it is not possible to be used for a target biofuel cell. Further, the transmission amount from the fuel reforming unit 12 can be adjusted so as not to ruin the function of the biofuel cell in a case such that the amount of the secondary fuel reformed in the fuel reforming unit 12 is too large.

A concrete control method is not limited. For example, the fuel reforming unit 12 is provided with a sensor 231, an interruption plate or adjustment valve such as a shutter 232 capable of interrupting or adjusting passage of the secondary fuel is mounted between the fuel reforming unit 12 and the fuel refining unit 13 or between the fuel reforming unit 12 and the fuel supplying unit 13, and the state such as the property and the amount of the secondary fuel is detected by the sensor 231, and the interruption plate, the adjustment valve, or the like such as the shutter 232 is opened/closed in accordance with the state of the secondary fuel, thereby enabling transmission of the secondary fuel from the fuel reforming unit 12 to be controlled.

(d) Third Control Means 24

The third control means 24 is control means for controlling transmission of the secondary fuel from the fuel refining unit 14 on the basis of the state of the secondary fuel refined in the fuel refining unit 14. For example, transmission of the secondary fuel from the fuel refining unit 14 can be stopped in advance so as not to ruin the function of the biofuel cell in a case such that the secondary fuel refined in the fuel refining unit 14 has a property such that it is not possible to be used for a target biofuel cell. The transmission amount from the fuel refining unit 14 can be adjusted so as not to ruin the function of the biofuel cell in a case such that the amount of the secondary fuel refined in the fuel refining unit 14 is too large.

A concrete control method is not limited. For example, the fuel refining unit 14 is provided with a sensor 241, an interruption plate or adjustment valve such as a shutter 242 capable of interrupting or adjusting passage of the secondary fuel is mounted between the fuel refining unit 14 and the electrolyte supplying unit 15 or between the fuel refining unit 14 and the fuel supplying unit 13, and the state such as the property and the amount of the secondary fuel is detected by the sensor 241, and the interruption plate, the adjustment valve, or the like such as the shutter 242 is opened/closed in accordance with the state of the secondary fuel, thereby enabling transmission of the secondary fuel from the fuel refining unit 14 to be controlled.

(e) Electrolyte Control Means 25

The electrolyte control means 25 is means for controlling the supply amount of the electrolyte solution from the electrolyte solution supplying unit 15 on the basis of the state of the secondary fuel refined in the fuel refining unit 14. By providing the electrolyte control means 25, the secondary fuel can be adjusted to an ideal fuel in accordance with the kind of a target biofuel cell.

A concrete control method is not limited. For example, the electrolyte solution supplying unit 15 is provided with a sensor 251, an electrolyte solution storing unit 253 storing the electrolyte solution is mounted so as to be connected to the electrolyte solution supplying unit 15 via a pump 252, the state such as the property and the amount of the secondary fuel is detected by the sensor 251, and the electrolyte solution of an amount according to the state is injected from the electrolyte solution storing unit 253 to the electrolyte solution supplying unit 15 via the pump 252, thereby enabling the fuel to be adjusted to an ideal fuel according to the target biofuel cell.

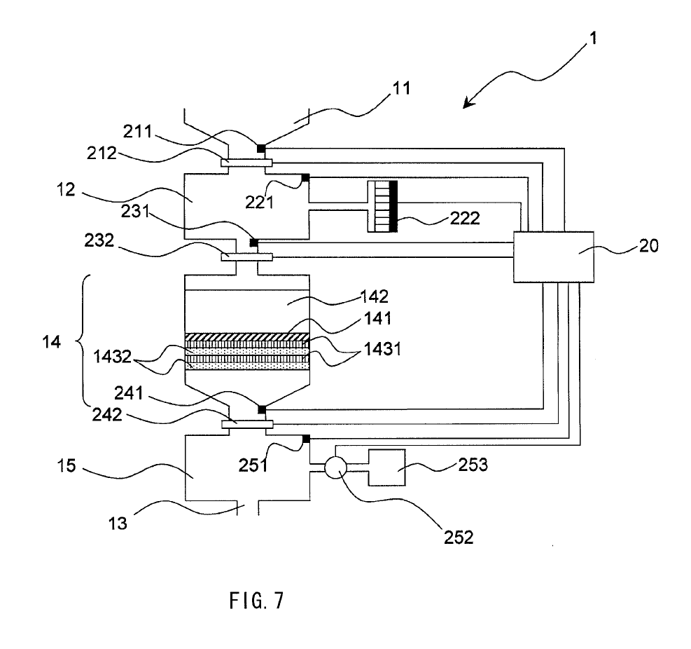

The various control means can be mounted in their target parts as shown in FIG. 6. For example, as shown in FIG. 7, it can be also designed so that all of the controls can be performed by single control means 20.

The fuel reformer 1 described above is designed so as to be connected to, for example, various biofuel cells and can be formed like a so-called cartridge.

The fuel reformer 1 can reform food and drink, skin lotions and the like taken in daily life, food scraps, and the like to those which can be used as fuel of a biofuel cell, so that the power source can be stably assured also at the time of disaster and the like.

<Power Generation Apparatus>

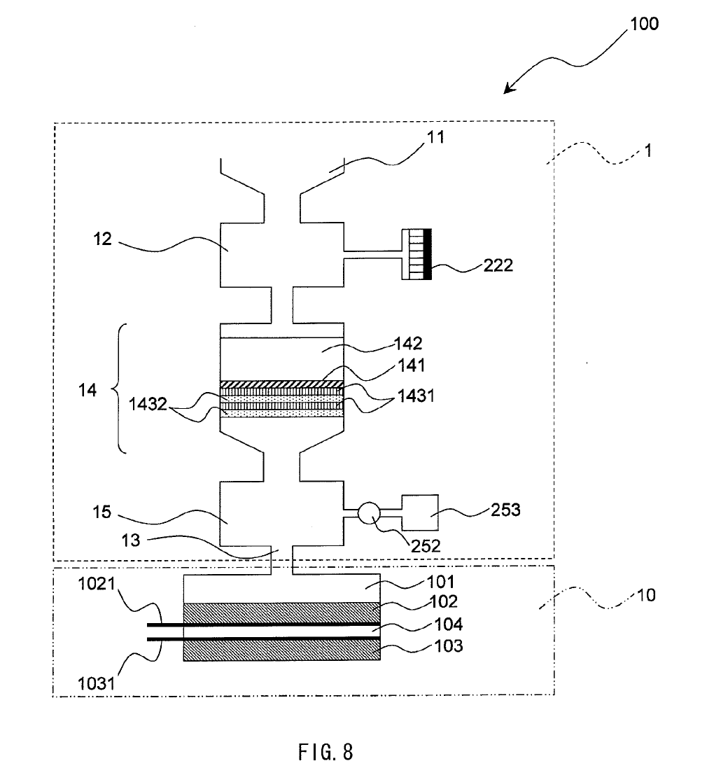

FIG. 8 shows the configuration of a power generation apparatus 100. The power generation apparatus 100 has the fuel reformer 1 and a fuel cell part 10. The fuel cell part 10 has a fuel tank 101, an anode 102, and a cathode 103. In the power generation apparatus 100, by reforming the primary fuel to the second fuel by the fuel reformer 1 and making an oxidation reduction reaction using enzyme of the secondary fuel as a catalyst progress, power is generated.

The power generation apparatus 100 can be constructed by using a plurality of fuel reformers 1 and a plurality of fuel cell parts 10. For example, a plurality of fuel cell parts 10 are connected in series and the fuel reformer 1 is provided for each of the fuel cell parts 10, or fuel can be supplied from one fuel reformer 1 to each of the fuel cell parts 10.

In the case where power is generated by a multistep conjugate enzyme reaction in the power generation apparatus 100 having the plurality of fuel cell parts 10, the conjugate enzyme reaction may be caused by one fuel cell part 10 step by step, or every plural steps. For example, a configuration may be employed in which a reaction intermediate generated by the enzyme reaction in one stage or plural stages in one fuel cell part 10 is supplied to the fuel tank 101 in another fuel cell part 10, and the enzyme reaction in the next stage is caused in the fuel cell part 10.

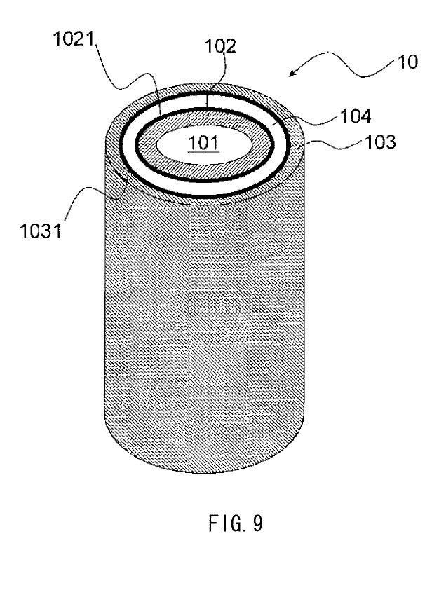

The form of the fuel cell part 10 is not also limited and can be freely designed according to an electronic device used. For example, the fuel cell part 10 can be designed in a cell structure of a conventional specification such as a cylindrical shape, a coin shape, or a button shape, or can be designed in a pipe-shape form in which an outer wall face is the cathode 103 and an inner wall face is the anode 102 as shown in FIG. 9, and fuel passes through the inside of the pipe. In the case of miniaturizing the fuel cell part 10, the structure may be devised to a shape or size so that it does not easily pass through the throat of a human in order to increase safety. Further, by making the members of flexible materials and deformable (for example, in a super-slim form), they can be applied to electronic devices (such as displays) in various forms. The configuration, function, effect, and the like of each of the components will be described below.

(1) Fuel Tank 101

The fuel tank 101 is used for storing the secondary fuel supplied from the secondary fuel supplying unit 13 of the fuel reformer 1. The shape of the fuel tank 101 is not limited but can be freely designed as long as it is a form capable of supplying the secondary fuel to the anode 102 which will be described later. The method of supplying the secondary fuel from the fuel tank 101 to the anode 102 is not limited but known methods can be freely selected. For example, by using the principle of pressure injection, negative-pressure injection, contact water absorption, or capillary action, the secondary fuel can be supplied to the anode 102.

The form of the fuel tank 101 is not limited as long as the purpose of the present invention is not disturbed, and can be freely designed in accordance with the kind of the fuel, the form of the power generation apparatus 100, and the kind and form of an electronic device used. In addition, it is also possible to construct an existing container storing a material which can become a fuel and the primary fuel introduction unit 11 of the fuel reformer 101 so as to be connected to each other and use the container as a fuel cartridge for supplying fuel to the fuel tank 101. Alternatively, a container and the anode 102 which will be described later may be constructed so as to be connected to each other and the container itself can be used as the fuel tank 101. Examples of the container include a plastic bottle, a fuel tank of a lighter, and an aluminum packaging member.

(2) Anode 102

In the anode 102 in the fuel cell part 10, when the oxidation reaction of the secondary fuel supplied from the fuel tank 101 progresses, electrons are released.

Since the power generation apparatus 100 has the fuel reformer 1, a foreign matter is hardly mixed in the secondary fuel supplied to the anode 102. However, it is preferable to provide foreign matter removing means such as a filter between the fuel tank 101 and the anode 102. By providing the foreign matter removing means, for example, a foreign matter such as a microorganism can be prevented from being supplied together with the secondary fuel to the anode 102. As a result, the power generation efficiency and the output value can be improved.

At the time of oxidation reaction of the fuel at the anode 102, there is a case such that an organic acid is generated collaterally because the fuel itself or a reaction intermediate (such as acetaldehyde, formaldehyde, and an organic acid derived from a TCA circuit) are volatile, a carbon dioxide gas is generated as a final reactant, or fermentation is caused by a microorganism mixed as an impurity. Then, preferably, carbon dioxide and water generated are returned to the fuel tank 101 by using absorption and water-feed reaction or the like. Further, it is preferable to provide a safety valve for allowing pressure to escape in preparation for the case where the internal pressure rises sharply due to gas generated at the time of oxidation reaction in the vicinity of (including the connection part) the anode 102 and the fuel tank 101. The kind of the safety valve can be usually freely selected from valves used for allowing pressure to escape and is, for example, a check valve.

The material used for the anode 102 is not limited as long as it can be electrically connected to the outside, any known materials can be freely selected and used. Examples include metals such as Pt, Ag, Au, Ru, Rh, Os, Nb, Mo, In, Ir, In, Mn, Fe, Co, Ti, V, Cr, Pd, Re, Ta, W, Ge, and Hf, alloys such as alumel, brass, duralumin, bronze, nonmagnetic nickel, platinum rhodium, hyperco, permalloy, permender, nickel silver, and phosphor bronze, conductive polymers such as polyacetylenes, coal materials such as graphite and carbon black, borides such as HfB₂, NbB, CrB₂, and B₄O, nitrides such as TiN and ZrN, silicides such as VSi₂, NbSi₂, MoSi₂, and TaSi₂, and composites of the above.

To the anode 102, enzyme may be immobilized as necessary. For example, in the case of using a fuel containing alcohol as a secondary fuel, it is sufficient to immobilize oxidase which oxidation-decomposes alcohol. Examples of the oxidase include alcohol dehydrogenase, aldehyde reductase, aldehyde dehydrogenase, lactate dehydrogenase, hydroxypyruvate reductase, gly cerate dehydrogenase, formate dehydrogenase, fructose dehydrogenase, galactose dehydrogenase, glucose dehydrogenase, gluconate 5 dehydrogenase, and gluconate 2 dehydrogenase.

In addition, to the anode 102, in addition to the oxidase, oxidized coenzyme and coenzyme oxidase may be immobilized. Examples of the oxidized enzyme include nicotinamide adenine dinucleotide (hereinbelow, called NAD+), nicotinamide adenine dinucleotide phosphate (hereinbelow, called NADP+), (flavin adenine dinucleotide (hereinbelow, called FAD+), and pyrrollo-quinoline quinone (hereinbelow, called PQQ 2+). As the coenzyme oxidase, for example, diaphorase is mentioned.

In the anode 102, as the secondary fuel is oxidation decomposition, the oxidation reduction reaction such that the oxidized coenzymes are reduced to NADH, NAPH, FADH, and PQQH₂, respectively, as their reduced forms and, on the contrary, the reduced coenzymes are converted to the oxidized coenzymes by the coenzyme oxidase is repeated. When the reduced coenzymes are converted to the oxidized coenzymes, two electrons are generated.

Further, to the anode 102, in addition to the oxidase and the oxidized coenzyme, an electron transfer mediator may be immobilized in order to smooth the transfer of the generated electrons to the electrode. Although various materials can be used as the electron transfer mediator, it is preferable to use a compound having a quinone skeleton or a compound having a ferrocenyl skeleton. As a compound having the quinone skeleton, particularly, a compound having a naphthoquinone skeleton is preferable. Further, as necessary, another one or more kinds of compounds acting as an electron transfer mediator may be also used for immobilization together with the compound having the quinone skeleton and the compound having the ferrocenyl skeleton.

Concrete examples of the compound having the naphthoquinone skeleton include 2-amino-1,4-naphthoquinone (ANQ), 2-amino-3-methyl-1,4-naphthoquinone (AMNQ), 2-amino-3-carboxy-1,4-naphthoquinone (ACNQ), 2,3-diamino-1,4-naphthoquinone, 4-amino-1,2-naphthoquinone, 2-hydroxy-1,4-naphthoquinone, 2-methyl-3-hydroxy-1,4-naphthoquinone, vitamin K₁(2-methyl-3-phyty 1,4-naphthoquinone), vitamin K₂(2-farnesyl-3-methyl-1,4-naphthoquinone), and vitamin K₃(2-methy 1,4-naphthoquinone). In addition, as the compound having the quinone skeleton, for example, a compound having an anthraquinone skeleton or a derivative thereof, such as anthraquinone-1-sulfonate or anthraquinone-2-sulfonate can be also used. As the compound having the ferrocene skeleton, for example, vinyl ferrocene, dimethyl aminomethyl ferrocene, 1,1′-bis(diphenylphosphino)ferrocene, dimethyl ferrocene, ferrocene monocarbonic acid, or the like can be used. Further, as other compounds, for example, metallic complexes such as ruthenium (Ru), cobalt (Co), manganese (Mn), molybdenum (Mo), chromium (Cr), osmium (Os), iron (Fe), and cobalt (Co), a viologen compound such as benzyl viologen, a compound having a nicotinamide structure, a compound having a riboflavin structure, a compound having a nucleotide-phosphate structure, or the like can be used. More concrete examples include cis-[Ru(NH₃)₄C₁₂]^{1+/0}, trans-[Ru(NH₃)₄C₁₂]^{1+/0}, [Co(dien)₂]^{3+/2+}, [Mn(CN)₆]³⁻⁴⁻, [Mn(CN)₆]^{4-/5-}, [Cr(edta)(H₂O)]^{1-/2-}, [Cr(CN)₆]^{3-/4-}, methylene blue, pycocyanine, indigo-tetrasulfonate, luciferin, gallocyanine, pyocyanine, methyl apri blue, resorufin, indigo-trisulfonate, 6,8,9-trimethyl-isoalloxazine, chioraphine, indigo disulfonate, nile blue, indigocarmine, 9-phenyl-isoalioxazine, thioglycolic acid, 2-amino-N-methyl phenazinemethosulfate, azure A, indigo-monosulfonate, anthraquinone-1,5-disulfonate, alloxazine, brilliant alizarin blue, crystal violet, patent blue, 9-methyl-isoalloxazine, cibachron blue, phenol red, anthraquinone-2,6-disulfonate, neutral blue, bromphenol blue, anthraquinone-2,7-disulfonate, quinoline yellow, riboflavin, flavin mononucleotide (FMN), flavin adenine dinucleotide (FAD), phenosafranin, lipoamide, safranine T, lipoic acid, indulin scarlet, 4-aminoacridine, acridine, nicotinamideadenine dinucleotide (NAD), nicotinamide adenine dinucleotide phosphate (NADP), neutral red, cysteine, benzyl viologen(2+/1+), 3-aminoacridine, 1-aminoacridine, methyl viologen(2+/1+), 2-aminoacridine, 2,8-diaminoacridine, and 5-aminoacridine. In the chemical formulae, dien denotes diethylenetriamine and edta denotes ethylenediaminetetraacetate tetraanione, respectively.

In the case of immobilizing the enzyme, the coenzyme, the electron transfer mediator, or the like to the anode 102, as the immobilization method, various methods can be freely selected. For example, a method of using an immobilization carrier using, as cross liners, glutaraldehyde and poly-L-lysine, a method of using a polymer having protonic conductivity such as acrylamide, or the like can be used.

it is preferable to mount a sensor for detecting a reaction intermediate which is generated at the time of oxidation reaction in and around the anode 102. When the reaction intermediate can be sensed, prediction of power generation time, control on a fuel supply amount, determination on whether power can be generated or not, and the like can be performed.

At the time of manufacturing the fuel cell part 10, there is a case such that a metallic ion, a chemical substance, or the like which can become an inhibitor for the enzyme and the electron transfer mediator remains or is generated. When a metal ion, a chemical substance, or the like exists at the time of power generation, deterioration in power generation efficiency and deterioration in an output may be caused. Consequently, it is preferable to remove a metallic ion and a chemical substance which can become an inhibitor to a degree that there is no influence at the time of manufacture of the fuel cell part 10.

(3) Cathode 103

In the cathode 103 in the fuel cell part 10, reduction reaction progresses using electrons which are emitted from the anode 102 and transmitted via an anode collector 1021 and a cathode collector 1031 which will be described later and oxygen supplied from the outside.

It is preferable to provide foreign matter removing means such as a filter between the outside (air layer) and the cathode 103. By providing the foreign matter removing means, for example, a foreign matter such as a microorganism can be prevented from being supplied together with air to the cathode 103. As a result, the power generation efficiency and the output value can be improved.

The material used for the cathode 103 is not limited as long as it can be electrically connected to the outside, and any known materials can be freely selected and used. Examples include metals such as Pt, Ag, Au, Ru, Rh, Os, Nb, Mo, In, Ir, Zn, Mn, Fe, Co, Ti, V, Cr, Pd, Re, Ta, W, Zr, Ge, and I-If, alloys such as alumel, brass, duralumin, bronze, nonmagnetic nickel, platinum rhodium, hyperco, permalloy, permender, nickel silver, and phosphor bronze, conductive polymers such as polyacetylenes, coal materials such as graphite and carbon black, borides such as HfB2, NbB, CrB₂, and B₄C, nitrides such as TiN and ZrN, silicides such as VSi₂, NbSi₂, MoSi₂, and TaSi₂, and composites of the above.

To the cathode 103, enzyme may be immobilized as necessary. As an enzyme which can be immobilized to the cathode 103, any enzyme using oxygen as a reactive substrate and having oxidase activation can be freely selected as necessary regardless of the kind. For example, laccase, bilirubin oxidase, ascorbate oxidase, or the like can be used.

To the cathode 103, in addition to the oxidase, an electron transfer mediator may be immobilized in order to smooth reception of electrons generated in the anode 102 and transmitted via the anode collector and the cathode collector 1031. The kind of the electron transfer mediator which can be immobilized to the cathode 103 can be freely selected as necessary as long as the oxidation reduction potential is higher than that of the electron transfer mediator used for the anode, Examples include ABTS(2,2′-azinobis(3-ethylbenzoline-6-sulfonate)), K₃[Fe(CN)₆], RuO₄^{0/1-}, [Os(trpy)₃]^{3+/2+}, [Rh(CN)₆]^{3-/4-}, [Os(trpy)(dpy)(py)]^{3+/2+}, IrCl₆^{2-/3-}, [Ru(CN)₆]^{3-/4-}, OsCl₆^{2-/3-}, [Os(py)₂(dpy)₂]^{3+/2+}, [Os(dpy)₃]^{3+/2+}, Cu^{III/II}(H₂A₃)^{0/1-}, [Os(dpy)(py)₄]^{3+/2+}, IrBr₆^{2-/3-}, [Os(trpy)(py)₃]^{3+/2+}, [Mo(CN)₈]^{3-/4-}, [Fe(dpy)]^{3+/2+}, [MO(CN)₈]^{3-/4-}, Cu^{III/II}(H₂G₃a)^{0/1-}, [Os(4,4′-Me2-dpy)₃]^{3+/2+}, [Os(CN)₆]^{3-/4}, RuO₄^{1-/2-}, [Co(ox)₃]^{3-/4-}, [Os(trpy)(dpy)Cl]^{2+/1+}, I₃₋/I₋, [W(CN)₈]^{3-/4-}, [Os(2-Me-Im)₂(dpy)₂]^{3+/2+}, ferrocene carboxylic acid, [Os(Im)₂(dpy)₂]^{3+/2+}, [Os(4-Me-Im)₂(dpy)₂]^{3+/2+}, OsBr₆^{2-/3-}, [Fe(CN)₆]^{3-/4-}, ferrocene ethanol, [Os(Im)₂(4,4′-Me₂-dpy)₂]^{3+/2+}, [Co(edta)]^{1-/2-}, [Co(pdta)]^{1-/2-}, [Co(cydta)]^{1-/2-}, [Co(phen)₃]^{3+/2+}, [OsCl(1-Me-Im)(dpy)₂]^{3+/2+}, [OsCl(Im)(dpy)₂]^{3+/2+}, [Co(5-Me-phen)₃]^{3+/2+}, [Co(trdta)]^{1-/2-}, [Ru(NH₃)₅(py)]^{3+/2+}, [Co(dpy)₃]^{2+/3+}, [Ru(NH₃)₅(4-thmpy)]^{3+/2+}, Fe^{3+/2+}, malonate, Fe^{3+/2+}, salycylate, Ru(NH₃)₅(4-Me-py)]^{3+/2+}, [Co(trpy)₂]^{3+/2+}, [Co(4-Me-phen)₃]^{3+/2+}, [Co(5-NH₂-phen)₃]^{3+/2+}, [Co(4,7-(bhm)₂phen)^{3+/2+}, [Co(5,6-Me4-phen)₃]^{3+/2+}, trans(N)-[Co(gly)₃]^{0/1-}, [OsCl(1-Me-Im)(4,4′-Me2-dpy)₂]^{3+/2+}, [Fe(edta)]^{1-/2-}, [Co(4,7-Me₂-phen)₃]^{3+/2+}, [Co(4,7-Me₂-phen)₃]^{3+/2+}, [Co(3,4,7,8-Me4-phen)₃]^{3+/2+}, [Co(NH3)₆]^{3+/2+}, [Ru(NH₃)₆]^{3+/2+}, [Fe(ox)₃]^{3-/4-}, promazine (n=1) [ammonium form], chloramine-T, TMPDA (N,N,N′,N′-tetramethylphenylenediamine), porphrexide, syringaldazine, o-tolidine, bacteriochlorophyll a, dopamine, 2,5-dihydroxy-1,4-benzoquinone, p-amino-dimethylaniline, o-quinone/1,2-hydroxybenzene (catechol), p-aminophenoitetrahydroxy-p-benzoquinone, 2,5-dichloro-p-benzoquinone, 1,4-benzoquinone, diaminodurene, 2,5-dihyoxyphenylacetic acid, 2,6,2′-trichloroindophenol, indophenol, o-toluidine blue, DCPIP (2,6-dichlorophenolindophenol), 2,6-dibromo-indophenol, phenol blue, 3-amino-thiazine, 1,2-napthoquinone-4-sulfonate, 2,6-dimethyl-p-benzoquinone, 2,6-dibromo-2′-methoxy-indophenol, 2,3-dimethoxy-5-methyl-1,4-benzoquinone, 2,5-dimethyl-p-benzoquinone, 1,4-dihydoxy-naphthoic acid, 2,6-dimethyl-indophenol, 5-isopropyl-2-methyl-p-benzoquinone, 1,2-naphthoquinone, 1-naphthol-2-sulfonate indophenol, toluylene blue, TTQ (tryptophan tryptophylquinone) model (3-methyl-4-(3′-methylindol-2′-yl)indol-6,7-dione), ubiquinone (coenzyme Q), PMS (N-methylphenazinium methosulfate), TPQ (toga quinone or 6-hydroxydopa quinone), PQQ (pyrroloquinolinequinone), thionine, thionine-tetrasulfonate, ascorbic acid, PES (phenazine ethosulphate), cresol blue, 1,4-naphthoquinone, toluidine blue, thiazine blue, gallocyanine, thioindigo disulfonate, methylene blue, vitamin K3 (2-methyl-1,4-naphthoquinone), and the like. In chemical formulae, dpy denotes 2,2′-dipyridine, phen denotes 1,10-phenanthroline, and Tris denotes tris(hydroxymethyl)aminomethane, trey denotes 2,2′:6′,2″-terpyridine, Im denotes imidazole, py denotes pyridine, thmpy denotes 4-(tris)hydroxymethyl)methyl)pyridine, bhm denotes bis(bis(hydroxymethyl)methyl, G3a denotes triglycineamide, A3 denotes trialanine, ox denotes oxalate dianione, edta denotes ethylenediaminetetraacetate tetraanione, gly denotes glycinate anion, pdta denotes propylenediaminetetraacetate tetraanione, trdta denotes trimethylenediaminetetraacetate tetraanione, and cydta denotes 1,2-cyclohexanediaminetetraacetate tetraanione.

In the case of immobilizing the enzyme, the coenzyme, the electron transfer mediator, or the like to the cathode 103, as the immobilization method, various methods can be freely selected like the immobilization method in the anode 102. For example, a method of using an immobilization carrier using, as cross linkers, glutaraldehyde and poly-L-lysine, a method of using a polymer having protonic conductivity such as acrylamide, or the like can be used.

It is preferable to mount a sensor for detecting a reaction intermediate which is generated at the time of oxidation reaction in and around the cathode 103. When the reaction intermediate can be sensed, prediction of power generation time, control on a fuel supply amount, determination on whether power can be generated or not, and the like can be performed.

At the time of manufacturing the fuel cell part 10, there is a case such that a metallic ion, a chemical substance, or the like which can become an inhibitor for the enzyme and the electron transfer mediator remains or is generated. When a metal ion, a chemical substance, or the like exists at the time of power generation, deterioration in power generation efficiency and deterioration in an output may be caused. Consequently, it is preferable to remove a metallic ion and a chemical substance which can become an inhibitor to a degree that there is no influence at the time of manufacture of the fuel cell part 10.

(4) Proton Conductor 104

The anode 102 and the cathode 103 described above are connected in a state where proton conduction is possible. The connecting method is not limited. For example, as shown in an embodiment of FIG. 8, by disposing the anode 102 and the cathode 103 so as to face each other via a proton conductor 104 in the fuel cell part 10, the anode 102 and the cathode 103 can be connected so that proton conduction is possible.

The material used for the proton conductor 104 is not limited as long as it does not have electron conductivity and is an electrolyte capable of transporting H+, and all of known materials can be selected and used. For example, an electrolyte containing a buffer substance can be used. Examples of the buffer substance include a compound containing an imidazole ring such as dihydrogenphosphate ions (H₂PO₄⁻) generated by sodium dihydrogen phosphate (NaH₂PO₄), potassium dihydrogen phosphate (KH₂PO₄), or the like, 2-amino-2-hydroxymethyl-1,3-propanediol (abbreviated name is tris), 2-(N-morpholino) ethane sulfonic acid (MES), cacodylic acid, carbonic acid (H₂CO₃), hydrogen citrate ion, N-(2-acetoamide)iminodiacetic acid (ADA), piperazine-N,N′-bis(2-ethanesulfonic acid) (PIPES), N-(2-acetoamide)-2-aminoethanesulfonic acid (ACES), 3-(N-morpholino)propanesulfonic acid (MOPS), N-2-hydroxyethyl piperazine-N′-2-ethanesulfonic acid (HEPES), N-2-hydroxyethyl piperazine-N′-3-propanesulfonic acid (HEPPS), N-[tris(hydroxymethyl)methyl]glycine (abbreviated name is tricine), glycylglycine, N,N-bis(2-hydroxyethyl)glycine (abbreviated name is bicin), imidazole, triazole, pyridine derivative, bipyridine derivative, imidazole derivatives (histidine, 1-methyl imidazole, 2-methyl imidazole, 4-methyl imidazole, 2-ethyl imidazole, imidazole-2-caroxylic acid ethyl, imidazole-2-carboxy aldehyde, imidazole-4-carboxylic acid, imidazole-4,5-dicarboxylic acid, imidazole-1-yl-acetic acid, 2-acetyl benzimidazole, 1-acetylimidazole, N-acetylimidazole, 2-amino benzimidazole, N-(3-aminopropyl) imidazole, 5-amino-2-(trifluoromethyl)benzimidazole, 4-azabenz imidazole, 4-aza-2-mercaptobenz imidazole, benzimidazole, 1-benzyl imidazole, and 1-butyl imidazole). Nafion membranes as solid electrolytes can be also used.

(5) Anode Collector 1021 and Cathode Collector 1031

Each of the anode collector 1021 and the cathode collector 1031 is connected to an external circuit. The anode collector 1021 and the cathode collector 1031 play the role of making electrons emitted from the anode 102 move to the cathode collector 1031 via the external circuit from the anode collector 1021 and sending them to the cathode 103.

In the embodiment, the proton conductor 104 is sandwiched by the anode collector 1021 and the cathode collector 1031. However, the invention is not limited to the configuration. For example, the anode collector 1021 may be formed so as to transmit the secondary fuel and disposed on the side opposite to the face on which the proton conductor 104 is stacked, of the anode 102. The cathode collector 1031 may be formed so as to transmit oxygen and disposed on the side opposite to the face on which the proton conductor 104 is stacked, of the cathode 103. Further, the anode collector 1021 and the cathode collector 1031 can be disposed so as to penetrate the inside of the anode 102 and the cathode 103.

The material used for the anode collector 1021 and the cathode collector 1031 is not limited as long as it can be electrically connected to the outside, and any known materials can be freely selected and used. Examples include metals such as Pt, Ag, Au, Ru, Rh, Os, Nb, Mo, In, Ir, Zn, Mn, Fe, Co, Ti, V, Cr, Pd, Re, Ta, W, Zr, Ge, and Hf, alloys such as alumel, brass, duralumin, bronze, nonmagnetic nickel, platinum rhodium, hyperco, permalloy, permender, nickel silver, and phosphor bronze, conductive polymers such as polyacetylenes, coal materials such as graphite and carbon black, borides such as HfB₂, NbB, CrB₂, and B₄C, nitrides such as TiN and ZrN, silicides such as VSi₂, NbSi₂, MoSi₂, and TaSi₂, and composites of the above.

Preferably, the fuel cell part 10 described above is provided with the temperature control function, the moisture control function, and the like. With the control functions, control is performed to the optimum temperature and optimum moisture of an enzyme used, and power generation efficiency and the output can be improved. With respect to a control method employed, known any methods can be freely used. For example, a temperature control method using a Peltier element, a method using a dehumidification agent (silica gel or the like), and the like may be employed. In addition, by devising the configuration to use heat generation from an electronic device used, sunlight, body temperature of a living body, frictional heat, and the like and maintaining the temperature to the optimum temperature of an enzyme used, the power generation efficiency and the output can be also improved.

Since the fuel cell part 10 of the power generation apparatus is a biofuel cell which generates power by using enzyme, the configuration can be devised so as to use enzyme produced by a living body (including animals and plants). For example, with a configuration that fuel is supplied from the inside or the surface of a living body, oxygen is supplied from the surface of the living body, and power is generated by using the enzyme in the living body (body-implant-type fuel cell part 10), a high output can be obtained.

<Electronic Device>

The power generation apparatus 100 can perform efficient power generation using, as a fuel, food, lotion, and the like used in daily life or food scraps, so that it can be suitably used for all of known electronic devices.

In the case of connecting or providing the power generation apparatus 100 to/in an electronic device, preferably, a boosting circuit or step-down circuit is provided as necessary between the fuel cell part 10 and the electronic device. The kind of the boosting circuit or step-down circuit is not limited. A known circuit which can be used for a biofuel cell can be freely selected and used.

The structure, function, and the like of an electronic device started by using the power generation apparatus 100 are not limited. The electronic device includes all of devices which electrically operate. Examples of the electronic device include a cellular phone, a mobile device, a robot, a personal computer, a game device, an in-vehicle device, a home electric appliance, an electronic device for an industrial product and the like, a vehicle, a motorcycle, an airplane, a rocket, a moving body such as a space ship, testing equipment, a power source for a pacemaker, a medical device such as a power source of an in-vivo device including a biosensor, a power generation system and a cogeneration system of a system for decomposing food scraps and generating electric energy, and the like.

Since the power generation apparatus 100 can be formed in various forms as described above, the form of an electronic device using it can be also freely designed. The electronic device can be formed, for example, in addition to the above-described existing electronic devices, in a casing in the form of a cell, a living body (including plants and animals), the earth, or the like.

By using a material having biodegradability for an electronic device, the burden on the nature environment can be also lessened. Further, preferably, each of members used for an electronic device is subjected to a sterilizing or disinfection treatment at a manufacture stage, a shipping stage, or an operation or discarding stage. As the sterilizing or disinfection method, a method usually used can be freely selected and employed. Examples of the method include pressurization process, heating process, very-low-temperature process, optical process, chemical treatment, surface coating, and preservative agent adding process.

The electronic device has the fuel cell part 10. The electronic device can be also formed in a hybrid configuration so that a battery other than a bio cell usually used for power supply can be also used. As cells used in this occasion, usually one or more kinds of cells which can be used for an electronic device can be freely selected and used. For example, a lithium ion cell, a fuel cell, a dry cell, a solar cell, and the like can be used.

Preferably, the electronic device is provided with means for displaying a remaining capacity or a power generation state of the fuel cell part 10 and another cell (in the case of a hybrid configuration). With the configuration, for example, the user can control a fuel supply amount while recognizing the remaining amount of the fuel cell part 10 and switch to a power supply from another cell in accordance with the remaining capacity of the fuel cell part 10.

Further, by giving a mechanical energy to the electronic device, power is generated. The fuel cell part 10 and another cell are charged with the generated power, and the charge electric energy is converted again to a mechanical energy. In such a manner, power can be given to the electronic device. Examples include a hand-cranked radio and an electric bicycle with a weight loosing function.

In the present invention, preferably, the components of the electronic device (the fuel reformer 1, the fuel tank 101 in the fuel cell part 10, the anode 102, the cathode 103, and the like) can be switched as necessary. One of methods is that, when the characteristic of the fuel cell part 10 deteriorates, the user pays consideration to generate a mechanical energy for mental or physical improvement, charge the electronic device, and collect the electronic device, thereby enabling the electric energy to be used for another thing.

In addition, an amount of carbon is calculated from a fuel use amount, a power generation amount, an amount of carbon dioxide, and the like and displayed in the electronic device of the present invention. In such a manner, the degree of contribution to the environment can be visually displayed.

For each of the fuel reformer 1, the power generation apparatus 100, and the electronic device, it is preferable to mount the following sensor.

(a) Fuel Sensor

A fuel sensor detects the amount, density, kind, and the like of a fuel. For example, it is preferable to mount the fuel sensor for the primary fuel introduction unit 11 and the secondary fuel supplying unit 12 in the fuel reformer 1, and the fuel tank 101, the anode 102 and its periphery, the cathode and its periphery in the fuel cell part 10, and the like. By obtaining the information, prediction of power generation time, control on the fuel supply amount, determination of whether power can be generated or not, and the like can be performed. Further, if the presence or absence of a fuel can be recognized in the anode 102 and its periphery, deterioration in the power generation efficiency and output can be prevented.

(b) Temperature Sensor

A temperature sensor measures temperature in a predetermined place. For example, it is preferable to mount a temperature sensor in the fuel cell part 10 and its periphery, in the electronic device or the surface of the electronic device, and the like. By detecting the temperature in those places, temperature control optimum to power generation can be performed.

(c) Oxygen Sensor

An oxygen sensor detects amount, concentration, and the like of oxygen. For example, it is preferable to mount the oxygen sensor in the fuel cell part 10 and its periphery, in/on the electronic device, in the cathode 103 and its periphery in the fuel cell part 10, and the like.

By detecting the presence/absence or concentration of acid in those places, control on the oxygen supply amount, determination of whether power can be generated or not, and the like can be performed. By using a light sensor as the oxygen sensor, the presence/absence of oxygen can be also detected.

(d) Carbon Dioxide Sensor

A carbon dioxide sensor detects the amount, concentration, and the like of carbon dioxide. For example, it is preferable to mount the carbon dioxide sensor for the primary fuel introduction unit 11 and the secondary fuel supplying unit 12 in the fuel reformer 1, and the fuel tank 101, the anode 102 and its periphery, the cathode and its periphery in the fuel cell part 10, and the like. By detecting the presence or absence or concentration of carbon dioxide in those places, prediction of power generation time, control on the fuel supply amount, determination of whether power can be generated or not, and the like can be performed.

(e) Gravity Center Sensor

A gravity center sensor detects a change in the center of gravity due to movement of a fuel or the like. For example, it is preferable to mount the gravity center sensor in the fuel cell part 10, the fuel tank 101 in the fuel cell part 10, the electronic device, and the like. By detecting the center of gravity in those places, backward flow or convection flow of the fuel, fuel leakage, or the like is detected, and the detection can be fed back to the power generation characteristic.

(f) Liquid Sensor

A liquid sensor detects the presence or absence of invasion, water pressure, and the like of a liquid in a predetermined place. For example, it is preferable to mount the liquid sensor in the fuel cell part 10, the cathode 102 and its periphery in the fuel cell part 10, in/on the electronic device, and the like. For example, in the case where liquid enters from the outside such as the case where the electronic device or the like is dropped in water or the case where the electronic device or the like is used in a watery place, the invasion path is interrupted so that the influence on power generation can be suppressed.

### Example 1

In the fuel reformer and the power generation apparatus according to the embodiment, an examination was made on whether power generation could be performed or not in the case of using cellulose as the primary fuel. As an example of cellulose, commercially-available toilet paper was used.

(1) Reforming of Fuel

First, 80 mg of commercially-available toilet paper which was cut in small pieces was prepared. 4,000 μL of a cellulase solution was added to the toilet paper and the resultant was left for one day, two days, and three days at room temperature or 50° C. or less.

(2) CV Measurement

The solution of 50 μL left for one day, two days, and three days was supplied to the fuel supply part in the power generation apparatus according to the present invention, and CV measurement was carried out. As the electrode of the fuel cell part, a carbon felt electrode was used. As the oxidase, glucose dehydrogenase (GDH) and diaphorase (DI) were used. As a coenzyme, NAD⁺ was used. As the electron transfer mediator, ANQ was used.

(3) Result

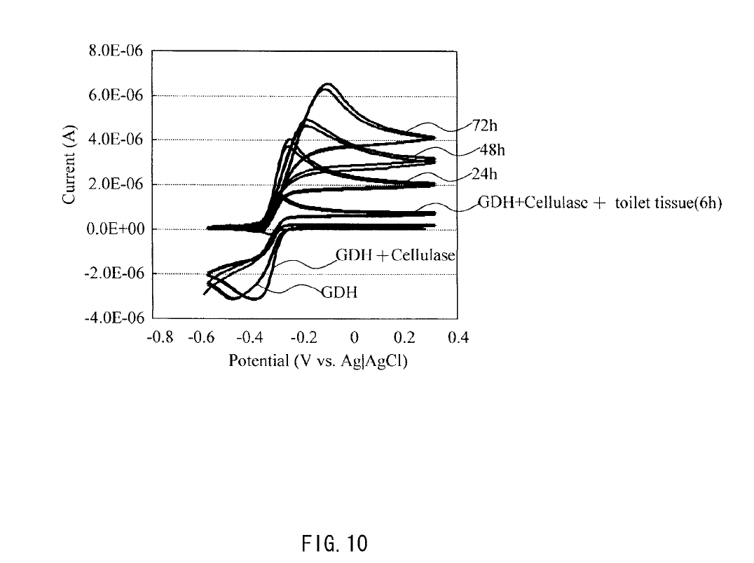

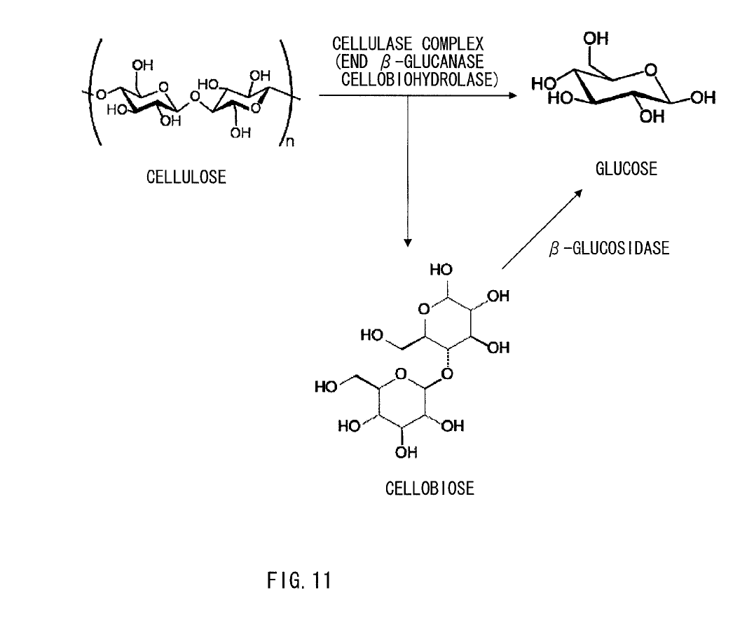

As shown in FIG. 10, it was understood that as the time of process with the cellulase solution becomes longer, the catalyst current increases. That is, it was understood that, as shown in FIG. 11, cellulose as the main component of the toilet paper was decomposed (reformed) to glucose by a plurality of enzymes including cellulase, thereby enabling power generation.

From the above, it was proved that by using the fuel reformer according to the invention, even in the case of using paper such as commercially-available toilet paper as a primary fuel, power generation can be realized.

What is claimed is:

1. A fuel reformer for use in a fuel cell which generates power when an oxidation reduction reaction progresses using enzyme as a catalyst, comprising:
a primary fuel introduction unit for introducing a primary fuel;
a fuel reforming unit communicating with the primary fuel introduction unit and reforming the primary fuel to a secondary fuel from which electrons can be emitted by an oxidation reduction reaction using enzyme as a catalyst; and
a secondary fuel supplying unit communicating with the fuel reforming unit and supplying the secondary fuel to the fuel cell.

2. The fuel reformer according to claim 1, further comprising a fuel refining unit for refining the secondary fuel, between the fuel reforming unit and the secondary fuel supplying unit.

3. The fuel reformer according to claim 2, wherein the fuel refining unit has a filter.

4. The fuel reformer according to claim 2, wherein the fuel refining unit has heating means.

5. The fuel reformer according to claim 2, wherein the fuel refining unit has an ion exchange resin layer.

6. The fuel reformer according to claim 1, further comprising first control means for controlling introduction of the primary fuel to the fuel reforming unit on the basis of a state of the primary fuel introduced in the primary fuel introduction unit.

7. The fuel reformer according to claim 1, further comprising reforming method selecting means for selecting a fuel reforming method in the fuel reforming unit on the basis of a state of the primary fuel introduced in the fuel reforming unit.

8. The fuel reformer according to claim 1, further comprising second control means for controlling transmission of the secondary fuel from the fuel reforming unit on the basis of a state of the secondary fuel reformed in the fuel reforming unit.

9. The fuel reformer according to claim 2, further comprising third control means for controlling transmission of the secondary fuel from the fuel refining unit on the basis of the state of the secondary fuel refined in the fuel refining unit.

10. The fuel reformer according to claim 2, further comprising an electrolyte solution supplying unit for supplying an electrolyte solution, between the fuel refining unit and the secondary fuel supplying unit.

11. The fuel reformer according to claim 10, further comprising electrolyte control means for controlling an electrolyte supply amount from the electrolyte solution supplying unit on the basis of the state of the secondary fuel refined in the fuel refining unit.

12. A power generation apparatus comprising:
a fuel reformer reforming a primary fuel to a secondary fuel; and
a fuel cell part which generates power by the secondary fuel,
wherein the fuel reformer includes:
a primary fuel introduction unit for introducing a primary fuel;
a fuel reforming unit communicating with the primary fuel introduction unit and reforming the primary fuel to a secondary fuel from which electrons can be emitted by an oxidation reduction reaction using enzyme as a catalyst; and
a secondary fuel supplying unit communicating with the fuel reforming unit and supplying the secondary fuel to the fuel cell, and
the fuel cell part has:
a fuel tank section storing the secondary fuel supplied from the secondary fuel supplying unit;
an anode communicating with the fuel tank section; and
a cathode connected to the anode in a state where proton conduction is possible.
